(19) United States
(12) Patent Application Publication
(10) Pub. No.: US 2009/0228201 A1
(43) Pub. Date: Sep. 10, 2009

(54) NAVIGATION METHOD AND APPLICATIONS THEREOF

(75) Inventor: Qi LIU, SHANGHAI CITY (CN)

Correspondence Address: Chih Feng Yeh;BRIAN M. MCINNIS, 12th Floor, Ruttonjee House, 11 Duddell Street, Hong Kong, HK

(73) Assignee: INVENTEC APPLIANCES CORP., TAIPEI HSIEN (TW)

(21) Appl. No.: 12/399,041

(22) Filed: Mar. 6, 2009

(30) Foreign Application Priority Data
Mar. 7, 2008 (TW) 97108159

(51) Int. Cl. G01C 21/00

(52) U.S. Cl. 701/201; 701/207

(57) ABSTRACT

A navigation method, a navigation apparatus, and a navigation system are disclosed. The method includes the following steps. A position of at least one hand-held device in an indoor environment is obtained. Positions of other hand-held devices in the indoor environment are then obtained to get information of distribution of some in the indoor environment, with at least one of the some carrying at least one of the other hand-held devices. And a position of a destination is obtained. A way from the position of the hand-held device to the position of the destination is then derived from the position of the hand-held device, the position of the destination, and the information of distribution.

### RELATED APPLICATIONS

This application claims priority to Taiwan Application Serial Number 97108159, filed Mar. 7, 2008, which is herein incorporated by reference.

### BACKGROUND

1. Field of Invention

The present invention relates to a navigation method, a navigation apparatus and/or a navigation system. More particularly, the present invention relates to a navigation method, a navigation apparatus and/or a navigation system for an indoor environment.

2. Description of Related Art

People, based on engineering developments, have enabled construction of huge buildings, such as skyscrapers. Huge buildings provide a new life experience for us. But they are built not just for economy of space. Like skyscrapers are also considered symbols of a city's economic power. Therefore, the word “skyscraper” originally was a term referring to a steel-framed ten-story building. But it has been changed now. For example, Taipei 101, a skyscraper in Taipei, Taiwan, has 101 stories above ground.

However, huge buildings also make some new problems, such as how to evacuate from the huge buildings in the event of an emergency. Therefore, how to solve those problems has been an urgent matter for modern people.

### SUMMARY

According to one embodiment of the present invention, a navigation method includes the following steps. A position of at least one hand-held device in an indoor environment is obtained. Positions of other hand-held devices in the indoor environment are obtained to get information of distribution of some in the indoor environment, with at least one of the some carrying at least one of the other hand-held devices. A position of a destination is obtained. A way from the position of the hand-held device to the position of the destination is derived from the position of the hand-held device, the position of the destination, and the information of distribution.

According to another embodiment of the present invention, a navigation apparatus for guiding one with at least one hand-held device in an indoor environment includes a server. The server includes a receiving device, a processor, and a transmitting device. The receiving device may obtain a position of the hand-held device. The processor may obtain positions of other hand-held devices in the indoor environment to get information of distribution of some in the indoor environment, with at least one of the some carrying at least one of the other hand-held devices. The processor may derive from the information of distribution an evacuation way to leave the indoor environment for the event of an emergency. The transmitting device may transmit the evacuation way to the hand-held device.

According to yet another embodiment of the present invention, a navigation system includes at least one hand-held device and a server. The hand-held device is located in an indoor environment. The server includes a receiving device, a processor, and a transmitting device. The receiving device may obtain a position of the hand-held device. The processor may obtain positions of other hand-held devices in the indoor environment to get information of distribution of some in the indoor environment, with at least one of the some carrying at least one of the other hand-held devices. The transmitting device may transmit the information of distribution to the hand-held device.

### BRIEF DESCRIPTION OF THE DRAWINGS

The invention can be more fully understood by reading the following detailed description of the embodiment, with reference made to the accompanying drawings as follows:

FIG. 1 is a flow chart of a navigation method according to one embodiment of the present invention;

FIG. 2 is a functional block diagram of a navigation apparatus according to another embodiment of the present invention;

FIG. 3 is a functional block diagram of the processor of FIG. 2;

FIG. 4 is a functional block diagram of a navigation system according to yet another embodiment of the present invention; and

FIG. 5 is a functional block diagram of the processor of FIG. 4.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

The size of modern buildings is huger than before, and thus the interior arrangement of the modern buildings is also more complex than before. As the pace of modern life continues to accelerate, the time is quite limited. Therefore, people often ask a question like this: “What is the quickest way to a destination from here?”

However, a huge building like a skyscraper is also a crowded place. Therefore, the shortest route may not be the quickest way when the distribution of people and things in the building is not considered. Accordingly, one embodiment of the present invention provides a navigation method that can determine a quickest way according to the distribution of people and things in the building.

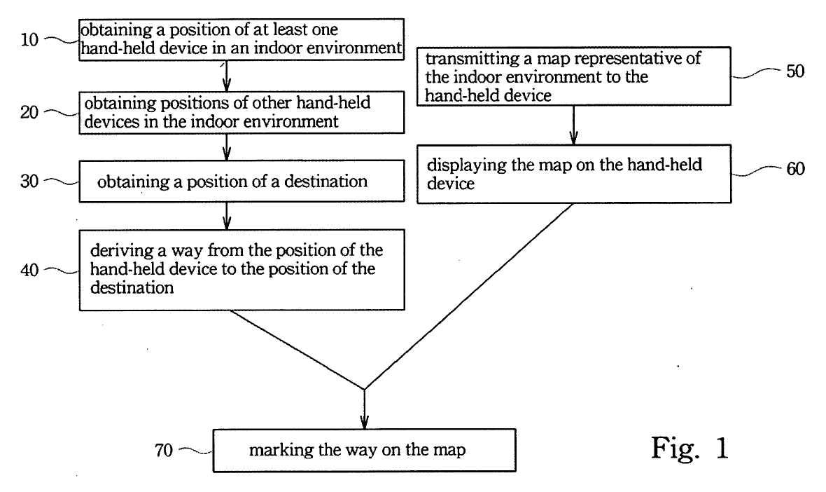

FIG. 1 is a flow chart of a navigation method according to one embodiment of the present invention. The navigation method includes the following steps:

(1) obtaining a position of at least one hand-held device in an indoor environment (step 10);

(2) obtaining positions of other hand-held devices in the indoor environment to get information of distribution of some in the indoor environment, with at least one of the some carrying at least one of the other hand-held devices (step 20);

(3) obtaining a position of a destination (step 30); and

(4) deriving a way from the position of the hand-held device to the position of the destination from the position of the hand-held device, the position of the destination, and the information of distribution (step 40).

The step 10 may be performed through a global positioning system (GPS). That is, at least one hand-held device in an indoor environment may employ a GPS receiver to calculate its position by carefully timing the signals sent by the GPS satellites high above the Earth. Then, the position of the hand-held device is uploaded to a server.

In the step 20, the server may obtain positions of other hand-held devices in the indoor environment to get information of distribution of some in the indoor environment, with at least one of the some carrying at least one of the other hand-held devices. It's noted that the some may include people, and/or things which may be entities of various types including e.g. animals and devices. Specifically, the positions of the other hand-held devices can be representative of the distribution of people who carry at least one of the other hand-held devices. That is, the information of distribution may concern or be about a distribution of people in the indoor environment. As another example, the information of distribution may further concern or be about a state of usage of at least one moving device in the indoor environment.

In the step 30, a user may directly input a position of a destination to the hand-held device. Alternatively, a plurality of locations in the indoor environment may be displayed on the hand-held device, and the user may select one of them as the destination. It is easily understood that the above-mentioned way to perform the step 30 is only one of the examples. Many other ways may be employed to find the position of the destination. People skilled in the art can select a proper one according to design and necessity.

In the step 40, a way from the position of the hand-held device to the position of the destination may be derived from the position of the hand-held device, the position of the destination, and the information of distribution. This way can guide the user to take a detour to avoid crowded regions in the indoor environment.

Specifically, in step 40, a shortest route from the position of the hand-held device to the position of the destination is determined first. Then, the shortest route is modified based on the information of distribution to obtain the way. Since the information of distribution may be about the distribution of people in the indoor environment, the user can get a quickest way around the crowded regions to the destination.

The way may be displayed on the hand-held device with at least one map representative of the indoor environment. In this way, the user may conveniently get the way by watching the display of the hand-held device even when walking to the destination. Specifically, the navigation method may further include the following steps:

(5) transmitting a map representative of the indoor environment to the hand-held device (step 50);

(6) displaying the map on the hand-held device (step 60); and

(7) marking the way on the map (step 70).

When the indoor environment has a plurality of floors, a plurality of the maps respectively representative of the floors of the indoor environment may be transmitted to the hand-held device. Specifically, a service center may be located in a specific place, for example the entrance of the indoor environment. This service center can provide a map download service that provides the map(s) to the hand-held device. Alternatively, the user may download the map(s) from Internet at home as well.

Although transmitting the maps together to the hand-held device is a convenient way to perform the step 50, the hand-held device may display a wrong map in some case since the GPS receiver may not find which floor the hand-held device is located on. In order to display the right map, a plurality of transmitters may be respectively located on the floors of the indoor environment for transmitting floor-indicating data to the hand-held device, with the floor-indicating data indicative of a floor of the plurality of floors. This floor-indicating data may be able to tell the hand-held device which floor the hand-held device is located on. Then, one of the maps is selected according to the floor-indicating data and then displayed on the hand-held device. Moreover, in the step 70, the way may be marked only on the selected map to avoid confusing the user.

In addition, the information of distribution may be employed to derive an evacuation way to leave the indoor environment for the event of an emergency, for example a fire. Another embodiment of the present invention provides a navigation apparatus that can derive an evacuation way from the information of distribution for the event of an emergency.

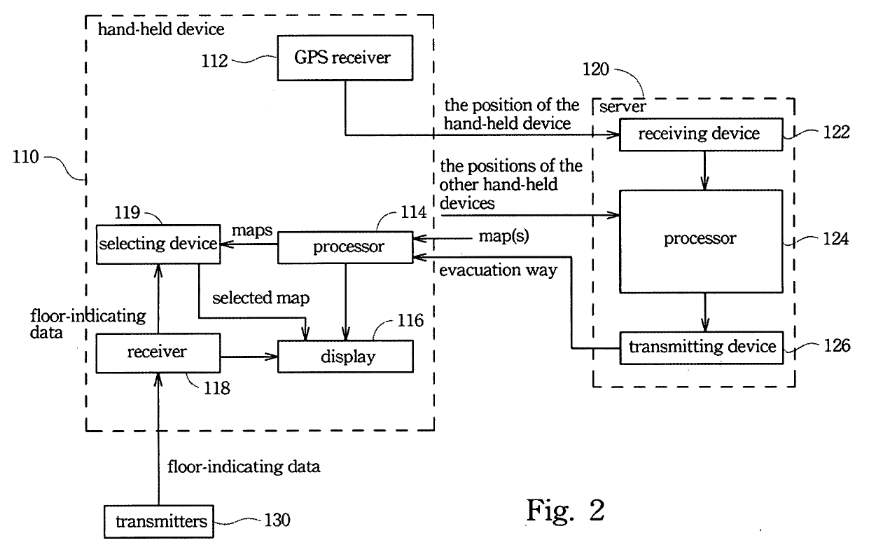

FIG. 2 is a functional block diagram of a navigation apparatus according to another embodiment of the present invention. As shown in FIG. 2, the navigation apparatus for guiding one with at least one hand-held device 110 in an indoor environment includes a server 120. The server 120 includes a receiving device 122, a processor 124, and a transmitting device 126. The receiving device 122 may obtain a position of the hand-held device 110. The processor 124 may obtain positions of other hand-held devices in the indoor environment to get information of distribution of some in the indoor environment, with at least one of the some carrying at least one of the other hand-held devices. It's noted that the some may include people, and/or things which may be entities of various types including e.g. animals and devices. The processor 124 may derive from the information of distribution an evacuation way to leave the indoor environment for the event of an emergency. The transmitting device 126 may transmit the evacuation way to the hand-held device 110.

The hand-held device 110 may employ a global positioning system (GPS) for finding the position of the hand-held device 110. Specifically, the hand-held device 110 may employ a GPS receiver 112 to calculate its position by carefully timing the signals sent by the GPS satellites high above the Earth. It is easily understood that the GPS is only one of the examples. Many other ways, for example an indoor positioning system, may be employed to find the position of the hand-held device 110. People skilled in the art can select a proper one according to design and necessity.

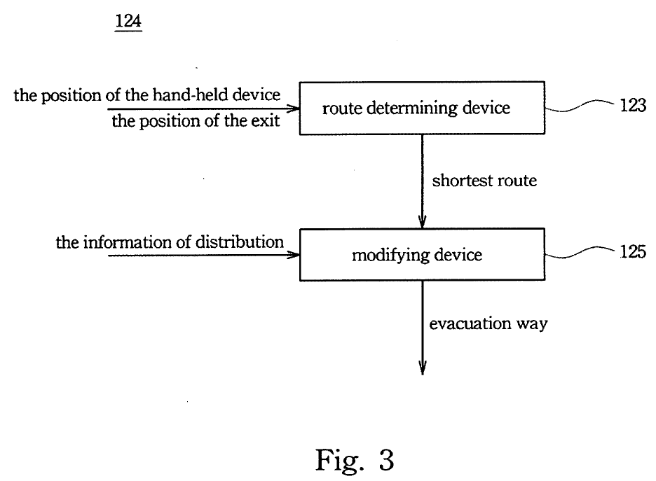

FIG. 3 is a functional block diagram of the processor 124 of FIG. 2. The processor 124 may includes a route determining device 123 and a modifying device 125. The route determining device 123 may determine a shortest route from the position of the hand-held device to a position of an exit of the indoor environment. The modifying device 125 may modify the shortest route based on the information of distribution to obtain the evacuation way.

Reference is made to FIG. 2. The hand-held device 110 may further include a processor 114 and a display 116. The processor 114 may download a map representative of the indoor environment to the hand-held device 110 from Internet or other proper places. The display 116, such as a liquid crystal display (LCD), may display the map on the hand-held device 110. Then, the downloading processor 114 may mark the evacuation way on the map. In this way, the evacuation way can be displayed on the hand-held device 110 with the map. Accordingly, people may conveniently get the evacuation way by watching the display 116 of the hand-held device 110 even when escaping from the indoor environment.

When the indoor environment has a plurality of floors, the processor 114 may download a plurality of maps respectively representative of the plurality of floors to the hand-held device 110. The processor 114 may download the maps separately or together according to actual requirements.

When the processor 114 downloads the maps together, the display 116 may display a wrong map in some case since the GPS receiver 112 may not find which floor the hand-held device 110 is located on. In order to display the right map, a plurality of transmitters 130 may be respectively located on the plurality of floors of the indoor environment for transmitting floor-indicating data to the hand-held device 110, with the floor-indicating data indicative of a floor of the plurality of floors. This floor-indicating data may tell the hand-held device 110 which floor the hand-held device 110 is located on. The hand-held device 110 may employ a receiver 118 to receive the floor-indicating data. Then, a selecting device 119 may select one of the maps according to the floor-indicating data, and the display module 116 may display the selected map on the hand-held device 110. Moreover, the downloading processor 114 may mark the evacuation way only on the selected map to avoid confusing the user.

The data transmission between the hand-held device 110 and the server 120 may be through wireless network communication. Similarly, the means of wireless network communication is only one of the examples. Other communication means may be employed to perform the data transmission between the hand-held device 110 and the server 120. People skilled in the art can select a proper one according to design and necessity.

In addition, the information of distribution may also be transmitted to the hand-held device for allowing the user of the hand-held device to use the information of distribution. Yet another embodiment of the present invention provides a navigation system that can provide the information of distribution to the hand-held device directly.

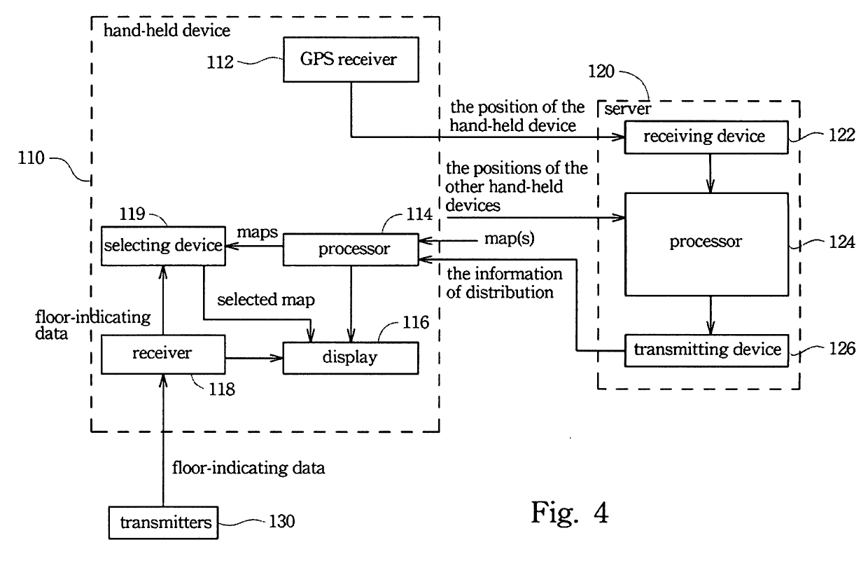

FIG. 4 is a functional block diagram of a navigation system according to yet another embodiment of the present invention. As shown in FIG. 4, the navigation system includes at least one hand-held device 110 and a server 120. The hand-held device 110 is located in an indoor environment. The server 120 includes a receiving device 122, a processor 124, and a transmitting device 126. The receiving device 122 may obtain a position of the hand-held device 110. The processor 124 may obtain positions of other hand-held devices in the indoor environment to get information of distribution of some in the indoor environment, with at least one of the some carrying at least one of the other hand-held devices. It's noted again that the some may include people, and/or things which may be entities of various types including e.g. animals and devices. The transmitting device 126 may transmit the information of distribution to the hand-held device 110.

The hand-held device 110 may employ a global positioning system (GPS) for finding the position of the hand-held device 110. Specifically, the hand-held device 110 may employ a GPS receiver 112 to calculate its position by carefully timing the signals sent by the GPS satellites high above the Earth. It is easily understood that the GPS is only one of the examples. Many other ways, for example an indoor positioning system, may be employed to find the position of the hand-held device 110. People skilled in the art can select a proper one according to design and necessity.

The main difference between the present embodiment (shown in FIG. 4) and the preceding embodiment (shown in FIGS. 2-3) is that the preceding embodiment keeps the information of distribution in the server 120 to determine the evacuation way, but the present embodiment transmits the information of distribution to the hand-held device 110 for allowing the user of the hand-held device 110 to use the information of distribution.

For example, the information of distribution can direct the user of the hand-held device 110 to take a detour to avoid crowded regions in the indoor environment. As shown in FIG. 4, the hand-held device 110 may further include a processor 114. The processor 114 may derive a way from the position of the hand-held device 110 to a position of a destination from the position of the hand-held device 110, the position of the destination, and the information of distribution.

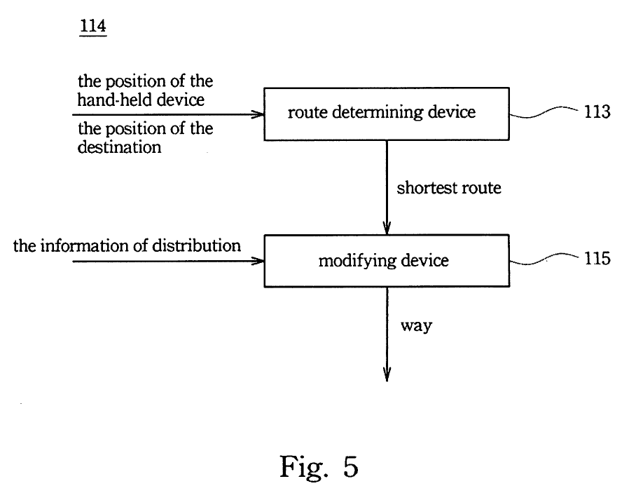

FIG. 5 is a functional block diagram of the processor 114 of FIG. 4. The processor 114 may include a route determining device 113 and a modifying device 115. The route determining device 113 may determine a shortest route from the position of the hand-held device 110 to the position of the destination. The modifying device 115 may modify the shortest route based on the information of distribution to obtain the way.

Reference is made to FIG. 4. The processor 114 of the hand-held device 110 may download a map representative of the indoor environment to the hand-held device 110. In the present embodiment, the hand-held device 110 may further include a display 116 for displaying the map on the hand-held device 110. Then, the processor 114 of the hand-held device 110 may mark the way on the map.

When the indoor environment has a plurality of floors, the processor 114 may download a plurality of maps respectively representative of the plurality of floors to the hand-held device 110. The processor 114 may download the maps separately or together according to actual requirements.

When the processor 114 downloads the maps together, the display 116 may display a wrong map in some case since the GPS receiver 112 may not find which floor the hand-held device 110 is located on. In order to display the right map, a plurality of transmitters 130 may be respectively located on the plurality of floors of the indoor environment for transmitting floor-indicating data to the hand-held device 110, with the floor-indicating data indicative of a floor of the plurality of floors. This floor-indicating data may be able to tell the hand-held device 110 which floor the hand-held device 110 is located on. The hand-held device 110 may employ a receiver 118 to receive the floor-indicating data. Then, a selecting device 119 may select one of the maps according to the floor-indicating data, and the display module 116 may display the selected map on the hand-held device. Moreover, the downloading processor 114 may mark the way only on the selected map to avoid confusing the user.

As to other elements of the navigation system, they are not described in detail since their structures and functions are the same as that of the preceding embodiment (shown in FIGS. 2-3).

In the preceding embodiments of the present invention, the term “hand-held device” may mean a personal digital assistant (PDA), an electronic dictionary, a digital camera, a cell phone or other electronic apparatus. People skilled in the art can select a proper one according to design and necessity.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A navigation method comprising:
obtaining a position of at least one hand-held device in an indoor environment;
obtaining positions of other hand-held devices in the indoor environment to get information of distribution of some in the indoor environment, with at least one of the some carrying at least one of the other hand-held devices;
obtaining a position of a destination; and
deriving a way from the position of the hand-held device to the position of the destination from the position of the hand-held device, the position of the destination, and the information of distribution.

2. The navigation method of claim 1, further comprising:
transmitting a map representative of the indoor environment to the hand-held device;
displaying the map on the hand-held device; and
marking the way on the map.

3. The navigation method of claim 1, further comprising:
transmitting a plurality of maps respectively representative of a plurality of floors of the indoor environment to the hand-held device;
transmitting floor-indicating data to the hand-held device, with the floor-indicating data indicative of a floor of the plurality of floors;
selecting one of the maps according to the floor-indicating data;
displaying the selected map on the hand-held device; and
marking the way on the selected map.

4. The navigation method of claim 1, wherein the step of deriving the way comprises:
determining a shortest route from the position of the hand-held device to the position of the destination; and
modifying the shortest route based on the information of distribution to obtain the way.

5. The navigation method of claim 1, wherein the step of obtaining the position of the hand-held device is performed through a global positioning system (GPS).

6. The navigation method of claim 1, wherein the information of distribution concerns a distribution of people in the indoor environment and a state of usage of at least one moving device in the indoor environment.

7. A navigation apparatus for guiding one with at least one hand-held device in an indoor environment, the navigation apparatus comprising:
a server comprising:
a receiving device for obtaining a position of the hand-held device;
a processor for obtaining positions of other hand-held devices in the indoor environment to get information of distribution of some in the indoor environment, with at least one of the some carrying at least one of the other hand-held devices, and for deriving from the information of distribution an evacuation way to leave the indoor environment for the event of an emergency; and
a transmitting device for transmitting the evacuation way to the hand-held device.

8. The navigation apparatus of claim 7, wherein the hand-held device comprises:
a processor for downloading a map representative of the indoor environment to the hand-held device; and
a display for displaying the map on the hand-held device,
wherein the downloading processor marks the evacuation way on the map.

9. The navigation apparatus of claim 7, further comprising:
a plurality of transmitters respectively located on a plurality of floors of the indoor environment for transmitting floor-indicating data to the hand-held device, with the floor-indicating data indicative of a floor of the plurality of floors.

10. The navigation apparatus of claim 9, wherein the hand-held device comprises:
a processor for downloading a plurality of maps respectively representative of the plurality of floors to the hand-held device;
a receiver for receiving the floor-indicating data;
a selecting device for selecting one of the maps according to the floor-indicating data; and
a display for displaying the selected map on the hand-held device,
wherein the downloading processor marks the evacuation way on the selected map.

11. The navigation apparatus of claim 7, wherein the processor for deriving the evacuation way comprises:
a route determining device for determining a shortest route from the position of the hand-held device to a position of an exit of the indoor environment; and
a modifying device for modifying the shortest route based on the information of distribution to obtain the evacuation way.

12. The navigation apparatus of claim 7, wherein the hand-held device employs a global positioning system (GPS) for finding the position of the hand-held device.

13. A navigation system comprising:
at least one hand-held device in an indoor environment; and
a server comprising:
a receiving device for obtaining a position of the hand-held device;
a processor for obtaining positions of other hand-held devices in the indoor environment to get information of distribution of some in the indoor environment, with at least one of the some carrying at least one of the other hand-held devices; and
a transmitting device for transmitting the information of distribution to the hand-held device.

14. The navigation system of claim 13, wherein the hand-held device comprises a processor for deriving a way from the position of the hand-held device to a position of a destination from the position of the hand-held device, the position of the destination, and the information of distribution.

15. The navigation system of claim 14, wherein the processor of the hand-held device downloads a map representative of the indoor environment to the hand-held device, the hand-held device further comprises a display for displaying the map on the hand-held device, and the processor of the hand-held device marks the way on the map.

16. The navigation system of claim 14, further comprising:
a plurality of transmitters respectively located on a plurality of floors of the indoor environment for transmitting floor-indicating data to the hand-held device, with the floor-indicating data indicative of a floor of the plurality of floors.

17. The navigation system of claim 16, wherein the processor of the hand-held device is for downloading a plurality of maps respectively representative of the plurality of floors to the hand-held device, and the hand-held device further comprises:
a receiver for receiving the floor-indicating data;
a selecting device for selecting one of the maps according to the floor-indicating data; and
a display for displaying the selected map on the hand-held device,
wherein the downloading processor marks the way on the selected map.

18. The navigation system of claim 14, wherein the processor of the hand-held device for deriving the way comprises:
a route determining device for determining a shortest route from the position of the hand-held device to the position of the destination; and
a modifying device for modifying the shortest route based on the information of distribution to obtain the way.

19. The navigation system of claim 13, wherein the hand-held device employs a global positioning system (GPS) for finding the position of the hand-held device.
